(19) United States
(12) Patent Application Publication
(10) Pub. No.: US 2007/0168212 A1
(43) Pub. Date: Jul. 19, 2007

(54) System, method, and program for adjusting work schedules

(75) Inventor: Junichi Murakawa, Tokyo (JP)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/636,287

(22) Filed: Dec. 7, 2006

(30) Foreign Application Priority Data
Dec. 26, 2005 (JP) 2005-373001

(51) Int. Cl. G06Q 99/00

(52) U.S. Cl. 705/1

(57) ABSTRACT

There is provided a system for adjusting a work schedule by sending email to employees who are not due to work to request them to change the work schedule if the number of employees due to work is less than a required number of employees. The system includes a receiver for receiving at least one application concerning a work schedule from an employee terminal and storing the at least one received application; a required-number-of-employees storage unit for storing a required number of employees at work; a calculator for calculating a number of employees due to work by accumulating the at least one received application; a determining unit for determining whether the number of employees due to work is less than the required number of employees; a selector for selecting at least one employee who is not due to work on a basis of the at least one store application if the number of employees due to work is less than the required number of employees; and a requester for sending a request to the at least one selected employee to change the work schedule.

### FIELD OF THE INVENTION

The present invention generally relates to systems, methods, and programs for adjusting work schedules. More specifically, the invention relates to a system, method, and program for assisting, in an organization in which the presence of a certain number of employees should always be guaranteed for achieving a task, in making adjustments for guaranteeing the presence of a required number of employees when an employee submits an application concerning a work schedule (for example, application for vacations).

### BACKGROUND OF THE INVENTION

In an organization, such as a company, a manager (for example, immediate manager) should manage a work schedule of employees so that nothing interferes with achieving a task. Accordingly, when employees wish to take vacations, or conversely, when they wish to work on days they do not usually work, a manager follows a procedure in which the employees are instructed to submit applications beforehand that are then approved or rejected.

When the manager receives an application for a vacation from an employee, the manager decides whether to approve the application by determining whether the vacation that that employee wishes to take would interfere with achieving a task. To make such a determination, it is necessary for the manager to check the schedules of all of the employees on the day of the requested vacation.

To address such a demand, for example, Japanese Unexamined Patent Application Publication No. 2004-21361 discloses the following system. If an applicant submits an application for a vacation on a certain day forgetting that they have work to do on that day, a boss receiving the application cannot check whether the applicant has work to do on that day. To solve such a problem, in this system, a schedule on the date when a vacation has been applied for is reported to an applicant terminal on the basis of information specifying the applicant and information concerning the date indicated in the application, and also, information concerning the schedule is reported to an approver terminal, which is specified on the basis of the information specifying the applicant.

In some organizations, a certain number of employees should be at work at the same time so that nothing interferes with achieving a task. In such organizations, if a manager realizes beforehand that many employees will take vacations on the same day and the number of employees working on that day will not be sufficient, the manager makes adjustments beforehand for guaranteeing the presence of a required number of employees. Such adjustments are made by asking some employees to change the day of the requested vacation. In this case, if the manager manages many employees, or if the task requires a specific qualification, such adjustments are time-consuming and troublesome.

### SUMMARY OF THE INVENTION

Accordingly, the present invention provides a system, a method, and a program for assisting, in an organization in which the presence of a certain number of employees should be guaranteed for achieving a task, in making adjustments for guaranteeing the presence of a required number of employees when an employee submits an application concerning a work schedule (for example, application for vacations).

The present invention provides a system for adjusting a work schedule by sending email to employees who are not due to work to request them to change the work schedule if the number of employees due to work is less than a required number of employees. The system includes a receiver for receiving at least one application concerning a work schedule from an employee terminal and storing the at least one received application, a required-number-of-employees storage unit for storing a required number of employees at work, a calculator for calculating a number of employees due to work by accumulating the at least one received application, a determining unit for determining whether the number of employees due to work is less than the required number of employees, a selector for selecting at least one employee who is not due to work on a basis of the at least one stored application if the number of employees due to work is less than the required number of employees, and a requester for sending a request to the at least one selected employee to change the work schedule.

If the number of employees due to work on the day indicated in the application becomes less than the required number of employees by the acceptance of the application, a message for requesting to stop the submission of the application may be displayed on the application screen.

The determining unit may re-determine whether the number of employees due to work becomes less than the required number of employees in response to the change of the required number of employees.

A priority level may be set according to each type of application, and the selector may select the one or more employees to whom the request is sent according to the priority level.

The system may further include an employee data storage unit for storing a qualification possessed by each employee. The required-number-of-employees storage unit may further stores qualifications demanded, and if a predetermined qualification is demanded for employees at work, the selector may refer to the employee data storage unit to select the one or more employees to whom the request is sent from among the employees possessing the predetermined qualification.

The system may further include an employee data storage unit for storing a work pattern of each employee. The required-number-of-employees storage unit may store the required number of employees according to each work pattern, and the selector may select the one or more employees to whom the request is sent in accordance with the work pattern.

The summary of the present invention has been discussed in the context of the system for adjusting a work schedule, and the present invention may encompass a method and a program for adjusting a work schedule.

In the above-described summary of the invention, not all features required for the invention have been described, and it should be noted that combinations or sub-combinations of the features of the invention may be encompassed in the invention.

According to the present invention, in a situation where the presence of a certain number of employees should be guaranteed for achieving a task, adjustments can be efficiently conducted without the need of direct talk between a manager and employees.

### BRIEF DESCRIPTION OF THE DRAWINGS

These and other features of this invention will be more readily understood from the following detailed description of the various aspects of the invention taken in conjunction with the accompanying drawings.

FIG. 1 is a system for adjusting a work schedule according to an embodiment of the present invention.

FIG. 2 is a functional block diagram illustrating the functions of the server of the system for adjusting a work schedule according to an embodiment of the present invention.

FIG. 3 illustrates an example of the vacation application screen displayed on the employee terminal according to an embodiment of the present invention.

FIG. 4 illustrates an example of the data structure of the application storage unit according to an embodiment of the present invention.

FIG. 5 illustrates an example of the data structure of the required-number-of-employees storage unit according to an embodiment of the present invention.

FIG. 6 illustrates an example of the data structure of a vacation-type storage unit according to an embodiment of the present invention.

FIG. 7 illustrates an example of the data structure of the employee data storage unit according to an embodiment of the present invention.

FIG. 8 illustrates an example of an email to request an employee to change the day of a vacation according to an embodiment of the present invention.

FIG. 9 is a flowchart illustrating the processing performed by the server of the system for adjusting the work schedule according to an embodiment of the present invention.

FIG. 10 illustrates an example of a hardware configuration of an information processing apparatus according to an embodiment of the present invention.

### DETAILED DESCRIPTION OF THE INVENTION

An embodiment of the present invention is described in detail below with reference to the accompanying drawings. However, the following embodiment is by no means intended to limit the scope of the claimed invention. Also, all the combinations of the features disclosed in the embodiment are not always essential for the solving means of the invention.

Further, the invention can be carried out in many various modes, and should not be interpreted by being restricted to the description of the embodiment. It should also be noted that all the combinations of the features disclosed in the embodiment are not always essential for the solving means of the invention. Throughout the description of the embodiment, like elements are designated with like reference numerals.

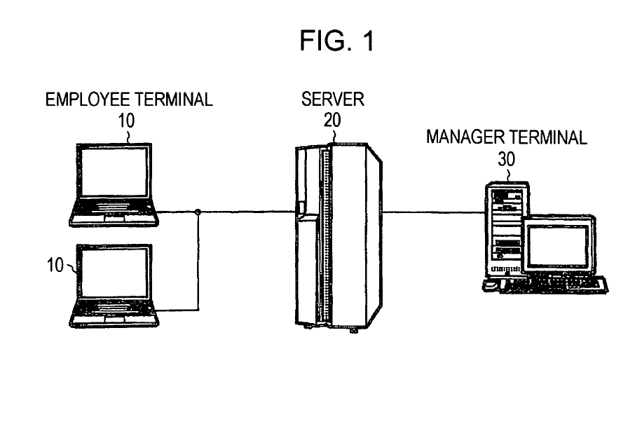

FIG. 1 is a system for adjusting a work schedule according to an embodiment of the present invention. The system for adjusting a work schedule includes a server 20, employee terminals 10, and a manager terminal 30. The server 20 receives applications concerning a work schedule input by employees, such as full-time employees, temporary employees, and part-time employees, from the employee terminals 10. The applications concerning a work schedule are applications for taking vacations. On the other hand, in an organization in which employees are required to submit applications regarding when they intend to work, the applications concerning a work schedule are applications for working. When receiving such an application, the manager of the employee who submitted the application checks the content indicated in the application on the manager terminal 30 and if the vacation does not cause any problem, the manager approves the application. For the convenience of description, it is now assumed that employees submit applications for vacations, unless otherwise stated.

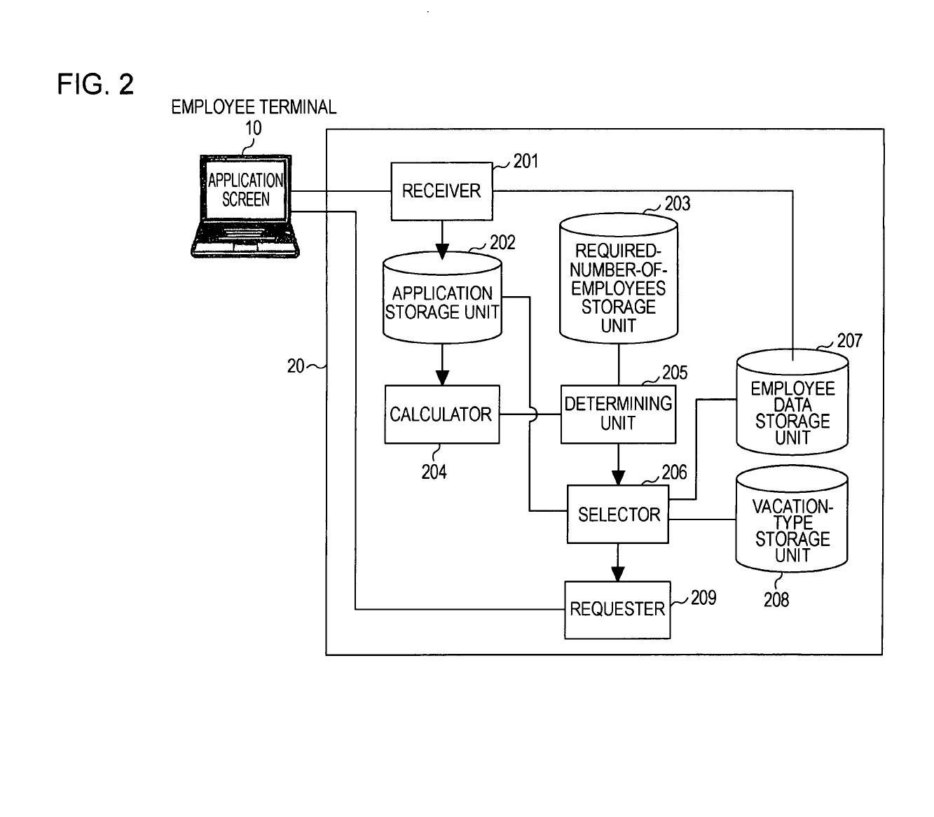

FIG. 2 is a functional block diagram illustrating the functions of the server 20 of the system for adjusting a work schedule according to an embodiment of the present invention. The server 20 includes a receiver 201, an application storage unit 202, a required-number-of-employees storage unit 203, a calculator 204, a determining unit 205, a selector 206, an employee data storage unit 207, a vacation-type storage unit 208, and a requester 209.

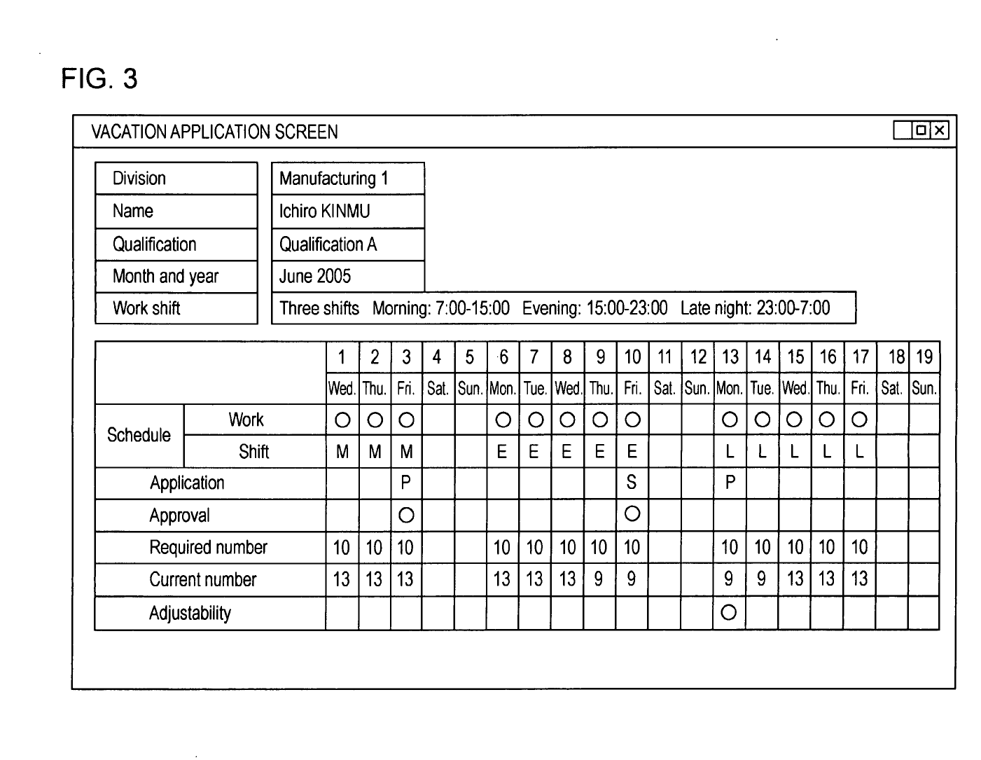

The receiver 201 first sends a vacation application screen to the employee terminal 10. FIG. 3 illustrates an example of the vacation application screen displayed on the employee terminal 10. The vacation application screen displays, as information for specifying an applicant, the applicant division, applicant name, and work pattern and shift pattern assigned to the applicant. The screen also displays the required qualification, the month and year subjected to work management, the applicant work schedule on the subject month and year, the type of application, information concerning whether the application has been approved, a required number of employees for achieving a task without any difficulty, the current number of employees due to work, and the possibility that the applicant can adjust the day of the vacation.

The applicant work schedule is displayed on the basis of information concerning the applicant work pattern stored in the employee data storage unit 207. The types of vacation include paid leave and special leave. The special leave means high priority leave that companies should/can not reject by the special reason, just like women's maternity leave. Accordingly, in a preferred embodiment, special leave is distinguished from paid leave, and a higher priority level is given to special leave. With this arrangement, applications for paid leave are approved only when the number of employees due to work on the subject day exceeds the required number of employees. On the other hand, applications for special leave are approved even when the number of employees due to work on the subject day is less than the required number of employees. In the example of this application screen, in the column of “application”, “P” means that paid leave has been applied for, while “S” means that special leave has been applied for.

The required number of employees is displayed on the basis of required-number-of-employees data stored in the required-number-of-employees storage unit 203, which is discussed below. As the required number of employees, the required number of employees is displayed in accordance with the applicant work pattern and shift pattern. The number of employees due to work is calculated on the basis of application information stored in the application storage unit 202, which is discussed below, and the calculated number of employees is displayed. In this manner, by displaying the required number of employees and the number of employees due to work, the applicant can check before applying for a vacation whether he/she can take a vacation without causing any problem. If the number of employees due to work is less than the required number of employees, the applicant is expected to voluntarily change the day of the vacation.

There may be some cases where, immediately after an employee has applied for a vacation, another employee applies for a vacation on the same day, and due to, for example, the timing of updating the data, the number of employees due to work becomes less than the required number of employees. In this case, if the application concerns regular paid leave rather than special leave, it is judged that the application is adjustable, and O is indicated in the column “adjustability”. This attracts the applicant attention, and the applicant is expected to voluntarily change the day of the vacation rather than being instructed to adjust the day of the vacation by the manager.

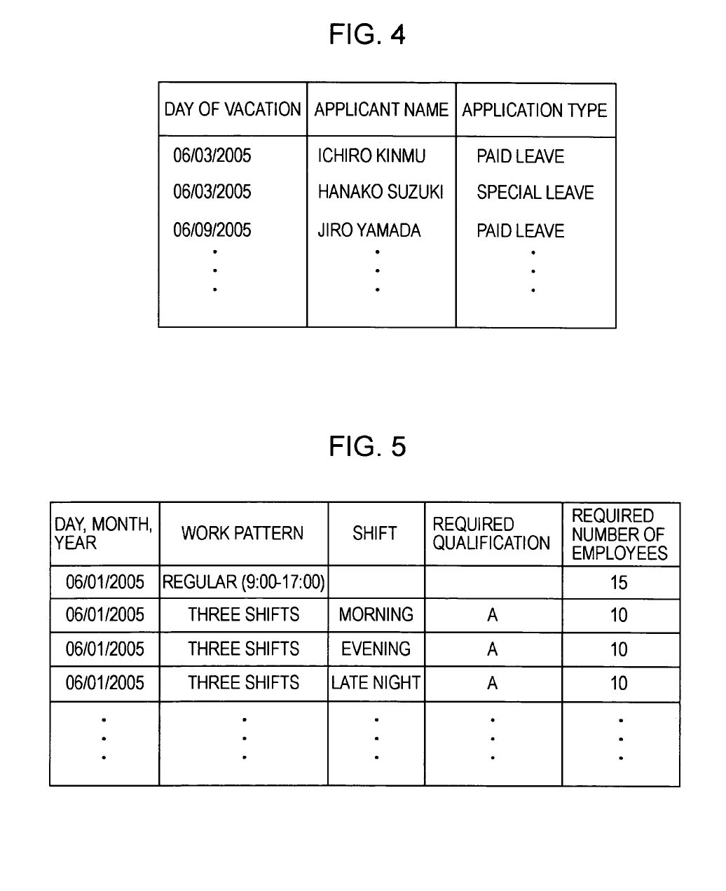

Referring back to the description with reference to FIG. 2, when the employee applies for a vacation through the vacation application screen, the receiver 201 receives the application sent from the employee terminal 10. The receiver 201 stores the information contained in the received application in the application storage unit 202. FIG. 4 illustrates an example of the data structure of the application storage unit 202. In the application storage unit 202, the days of vacations, the applicant names, and the application types (i.e., paid leave or special leave) are stored. In this example, on Jun. 3, 2005, Ichiro KINMU applied for paid leave, and Hanako SUZUKI applied for special leave.

The required-number-of-employees storage unit 203 stores a required number of employees on each working day. FIG. 5 illustrates an example of the data structure of the required-number-of-employees storage unit 203. The required-number-of-employees storage unit 203 stores a required number of employees on each day according to the work pattern, shift pattern, and required qualification. In this example, the required numbers of employees on Jun. 1, 2005 are indicated. Concerning regular work employees (9:00-17:00), 15 employees are required. Concerning shift (one of the morning, evening, and late-night shifts) work employees possessing qualification A, 10 employees are required.

The calculator 204 accumulates the number of applications for vacations of each working day to calculate the number of employees due to work. The number of applications for vacations can be calculated by accumulating the number of applications on each working day by referring to the application storage unit 202. The number of employees due to work can be calculated by subtracting the number of applications from the number of employees belonging to the corresponding organization. If employees are required to submit applications for when they intend to work, the number of applications is equal to the number of employees due to work. The calculated number of employees due to work is displayed, together with the required number of employees read from the required-number-of-employees storage unit 203, on the above-described vacation application screen.

The determining unit 205 determines whether the number of employees due to work calculated by the calculator 204 is less than the required number of employees. The required number of employees can be obtained from the required-number-of-employees storage unit 203. If the determining unit 205 determines that the number of employees due to work is less than the required number of employees, control is shifted from the determining unit 205 to the selector 206.

If an employee applies for a vacation on a day on which the number of employees due to work is less than the required number of employees, the receiver 201 may display on the application screen a message for requesting the employee to stop submitting an application, such as “On the day for which you are applying for a vacation, the number of employees required to achieve a task is not satisfied, kindly reconsider your application”. This may stop the employee voluntarily from taking a vacation on that day. Alternatively, if it is determined that the number of employees due to work is less than the required number of employees, the employee may be systematically stopped from submitting an application. In this case, a flag indicating whether to stop the submission of an application is provided for the required-number-of-employees storage unit 203, and the receiver 201 controls the receiving of applications by referring to the flag.

If the required number of employees stored in the required-number-of-employees storage unit 203 is changed, in particular, if the required number of employees is increased, the current number of employees due to work may become less than the required number of employees after being changed. Accordingly, in a preferred embodiment, if the required number of employees is changed, the determining unit 205 re-determines whether the number of employees due to work is less than the required number of employees.

The selector 206 selects employees who are not due to work, i.e., employees who have submitted applications, in order to send email to request them to change the day of the vacation. The employees who have submitted applications can be obtained by referring to the application storage unit 202. If employees are required to submit applications for when they intend to work, the employees stored in the application storage unit 202 are employees due to work, and the employees who are not due to work are employees who belong to the corresponding organization and who have not submitted applications. In this case, the selector 206 selects the employees who belong to the organization and who have not submitted applications by referring to the employee data storage unit 207, which is discussed below.

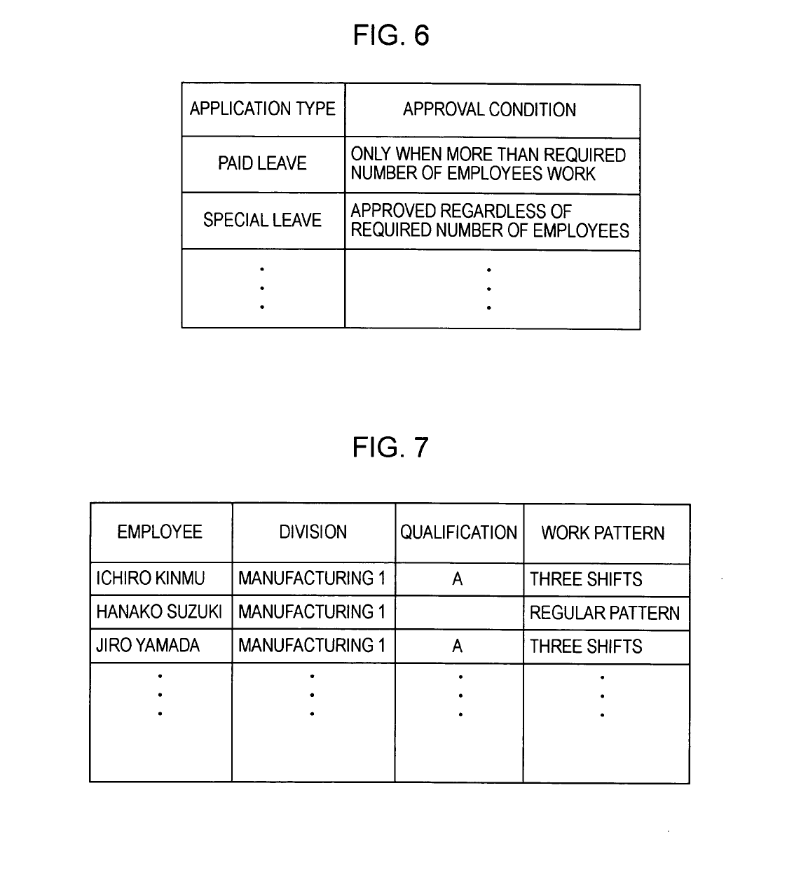

In a preferred embodiment, applications for vacations are classified into, for example, paid leave and special leave, and priority levels are assigned to the classified elements and are stored in the vacation-type storage unit 208. In the example shown in FIG. 6, the priority level of special leave is set to be higher than that of paid leave. Applications for paid leave are approved only when the number of employees due to work on the subject day exceeds the required number of employees. On the other hand, applications for special leave are approved even when the number of employees due to work on the subject day is less than the required number of employees.

Some tasks require employees possessing a predetermined qualification. Accordingly, in a preferred embodiment, the required-number-of-employees storage unit 203 discussed with reference to FIG. 5 stores a required number of employees possessing a predetermined qualification. The employee data storage unit 207 stores information concerning qualifications possessed by the individual employees. The selector 206 refers to the required-number-of-employees storage unit 203 to check whether a predetermined qualification is demanded for employees due to work. If so, the selector 206 refers to the employee data storage unit 207 to select employees who have submitted applications for vacations from among the employees possessing the predetermined qualification.

Some organizations have a plurality of work patterns (for example, regular work pattern, three-shift work pattern, working-at-home pattern). Accordingly, in a preferred embodiment, in the required-number-of-employees storage unit 203 discussed with reference to FIG. 5, the required number of employees is stored according to each work pattern, and the employee data storage unit 207 stores the work pattern of each employee. If the number of employees of a predetermined work pattern due to work is less than the required number of employees, the selector 206 refers to the employee data storage unit 207 to select the employees who have submitted applications from among the employees of that work pattern.

FIG. 7 illustrates an example of the data structure of the employee data storage unit 207. The employee data storage unit 207 stores the employee names, divisions, qualifications, and work patterns. In this example, Ichiro KINMU belongs to Manufacturing 1, possesses qualification A, and works in the three-shift pattern.

As described above, the selector 206 selects the employees to whom email is to be sent to request them to change the day of the vacation. However, if there have been many applications for special leave, which should be approved regardless of a required number of employees, there may be no employees who can be requested to change the day of the vacation from among the employees of the corresponding work pattern. In this case, the selector 206 can select employees of another work pattern. This makes it possible to send email to work-at-home pattern employees to request them to work in the office. If there are no employees who can be requested to change the day of the vacation in the corresponding organization, the selector 206 may select employees belonging to another organization and report the selected employees to the manager.

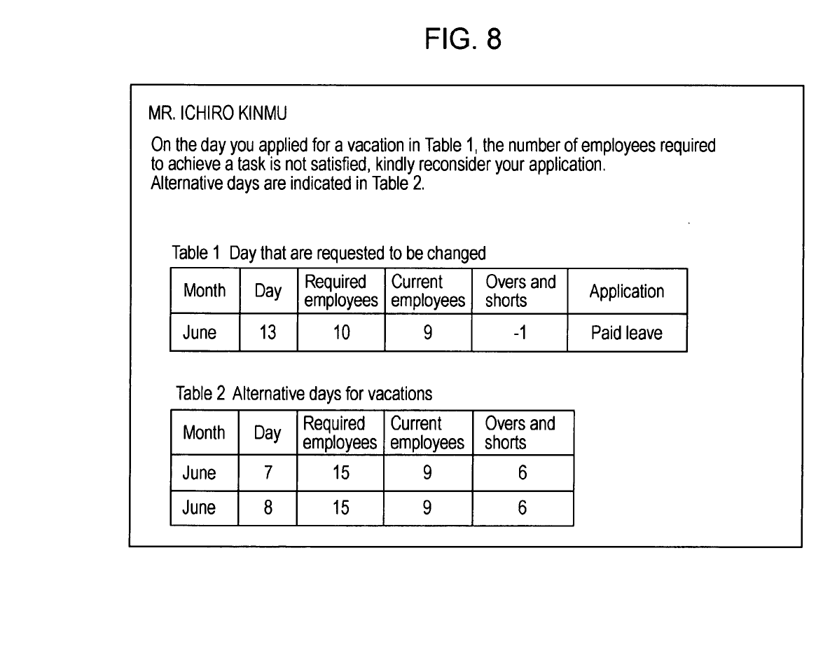

The requester 209 sends email to the employee selected by the selector 206 to request him/her to change the day of the vacation or to change the working-at-home day. FIG. 8 illustrates an example of email to request the employee to change the day of the vacation. In this email, for the convenience for the employee, alternative days when the employee can take a vacation are indicated together. The alternative days are selected from the days when there are more employees than a required number of employees at work.

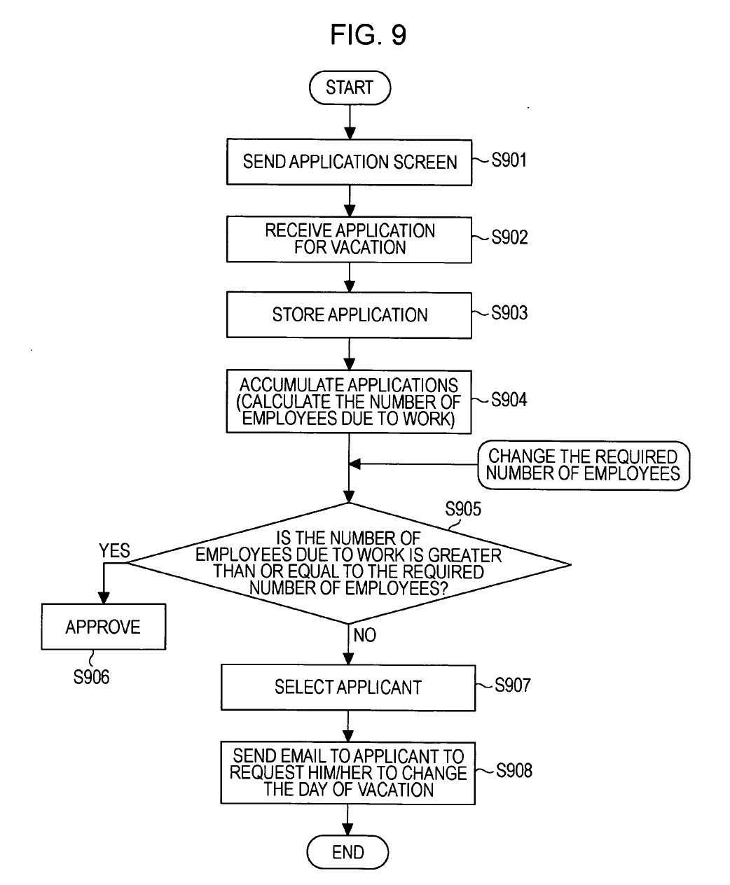

FIG. 9 is a flowchart illustrating the processing performed by the server 20 of the system for adjusting the work schedule according to an embodiment of the present invention. The receiver 201 of the server 20 sends an application screen to the employee terminal 10 (S901). An employee submits an application for a vacation, and then, the receiver 201 receives the application sent from the employee terminal 10 (S902). The content indicated in the application is stored in the application storage unit 202 (S903).

The calculator 204 accumulates the number of applications by referring to the application storage unit 202 (S904). The accumulation operation may be performed at regular intervals or every time an employee submits an application. In this accumulation operation, the number of employees due to work is calculated on the basis of the number of accumulated applications.

The determination unit 205 determines whether the calculated number of employees due to work is less than the required number of employees stored in the required-number-of-employees storage unit 203 (S905). If the number of employees due to work is not less than the required number of employees (S905: Yes), the application is approved (S906).

If the number of employees due to work is less than the required number of employees (S905: No), the selector 206 selects one or more employees who can be requested to change the day of the vacation, i.e., the applicant who has requested the vacation, by searching the application storage unit 202 (S907).

The requester 209 sends email to the selected employees to request them to change the day of the vacation (S908).

If the required number of employees stored in the required-number-of-employees storage unit 203 is increased, the determining unit 205 re-determines whether the number of employees due to work becomes less than the required number of employees after being changed (S905).

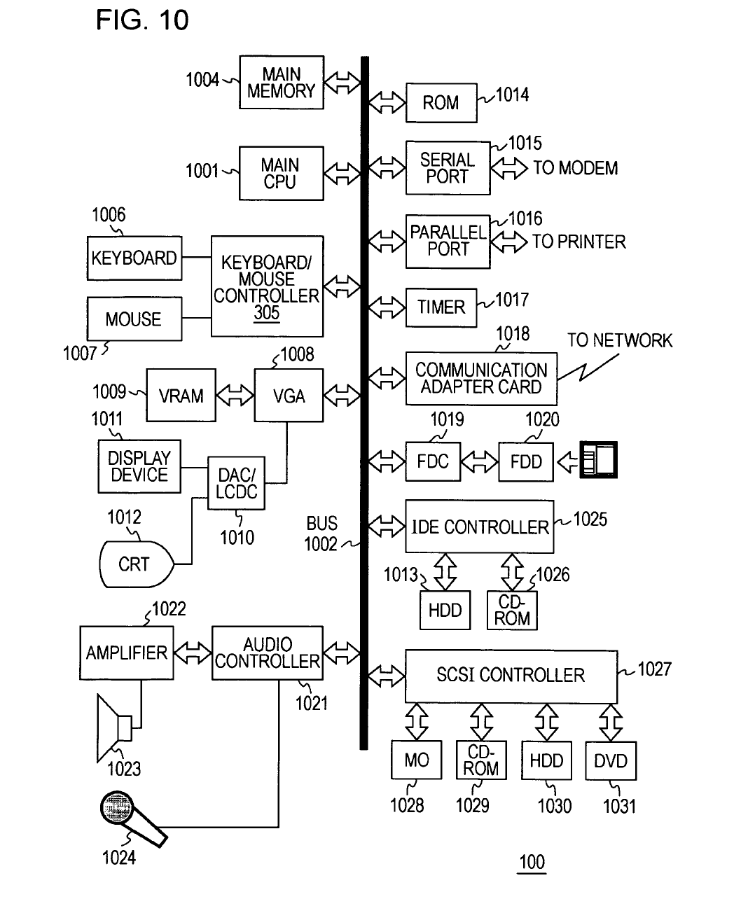

FIG. 10 illustrates an example of the hardware configuration of an information processing apparatus 100, which serves as the employee terminal 10, the server 20 of the system for adjusting a work schedule, or the manager terminal 30. The information processing apparatus 100 includes a CPU (central processing unit) 1001 and a main memory 1004 connected to a bus 1002. Removable storage devices (removable-recording-media external storage systems), such as hard disk drives 1013 and 1030, CD-ROM drives 1026 and 1029, a flexible disk drive 1020, an MO drive 1028, and a DVD-ROM drive 1031, are connected to the bus 1002 through an IDE controller 1025 or a SCSI controller 1027. The hard disk drive 1013 or 1030 may serve as the application storage unit 202, the required-number-of-employees storage unit 203, or the employee data storage unit 207 shown in FIG. 2.

A storage medium, such as a flexible disk, an MO, a CD-ROM, or a DVD-ROM, is installed in the removable storage device. Computer program code for sending commands to the CPU in cooperation with an operating system to carry out the present invention can be stored in the above-described storage media, the hard disk drives 1013 and 1030, and a ROM 1014. The computer program can be executed by being loaded into the main memory 1014. The computer program may be compressed or divided into a plurality of segments and be recorded on a plurality of recording media. The operation performed by the information processing apparatus 100 by being driven by the program is the same as the operation performed by the server 20 of the system for adjusting a work schedule, which has been discussed with reference to FIG. 9, and an explanation thereof is thus omitted.

The information processing apparatus 100 receives the inputs from user interface devices, such as a keyboard 1006 and a mouse 1007, via a keyboard/mouse controller 1005. The information processing apparatus 100 is connected through a DAC/LCDC 1010 to a display device 1011 for presenting visual data to users.

The information processing apparatus 100 can be connected to a network through a network adapter card 1018 (Ethernet® card or token ring card) to communicate with other computers.

According to the foregoing description, it can be easily understood that the information processing apparatus 100, which is suitable for implementing the work-schedule management assisting server 20 according to the embodiment of the present invention, is implemented by a mainframe, a workstation, an information processing apparatus, such as a general personal computer, or a combination thereof. The elements forming the information processing apparatus 100 are examples only, and not all the elements are essential for implementing the present invention.

Various modifications can be easily made to the invention by those who skilled in the art. For example, a plurality of machines may be combined, and the functions of the hardware elements forming the information processing apparatus 100 used in the embodiment of the present invention may be distributed into the combined machines and are executed. Such modifications are encompassed in the idea of the present invention.

While the present invention has been described with reference to the preferred embodiment, it is to be understood that the technical scope of the invention is not limited to the disclosed embodiment. It is apparent for those skilled in the art to add various modifications and improvements to the embodiment. The scope of the following claims is to be accorded the broadest interpretation so as to encompass such modifications and improvements.

What is claimed is:

1. A system for adjusting a work schedule, comprising:
a receiver for receiving at least one application concerning a work schedule from an employee terminal and storing the at least one received application;
a required-number-of-employees storage unit for storing a required number of employees at work;
a calculator for calculating a number of employees due to work by accumulating the at least one received application;
a determining unit for determining whether the number of employees due to work is less than the required number of employees;
a selector for selecting at least one employee who is not due to work on a basis of the at least one store application if the number of employees due to work is less than the required number of employees; and
a requester for sending a request to the at least one selected employee to change the work schedule.

2. The system according to claim 1, wherein the receiver displays at least the required number of employees and a current number of employees due to work on a day indicated in an application on an application screen of the employee terminal.

3. The system according to claim 2, wherein each application concerning the work schedule is an application for a vacation.

4. The system according to claim 3, wherein, if the number of employees due to work on a day indicated in an application becomes less than the required number of employees by an acceptance of the application, the receiver displays a message for requesting a stop to the submission of the application on the application screen.

5. The system according to claim 3, wherein an alternative day for taking a vacation is indicated in the request.

6. The system according to claim 1, wherein the determining unit re-determines whether the number of employees due to work becomes less than the required number of employees in response to a change of the required number of employees.

7. The system according to claim 1, wherein a priority level is set according to each type of application, and the selector selects the at least one employee to whom the request is sent according to the priority level.

8. The system according to claim 1, further comprising an employee data storage unit for storing a qualification possessed by each employee,
wherein the required-number-of-employees storage unit further stores qualifications demanded, and if a predetermined qualification is demanded for employees at work, the selector refers to the employee data storage unit to select the at least one employee to whom the request is sent from among the employees possessing the predetermined qualification.

9. The system according to claim 1, further comprising an employee data storage unit for storing a work pattern of each employee,
wherein the required-number-of-employees storage unit stores the required number of employees according to each work pattern, and the selector selects the at least one employee to whom the request is sent in accordance with the work pattern.

10. The system according to claim 9, wherein, if there are no employees of a required work pattern, the selector selects the at least one employee to whom the request is sent from among employees of another work pattern.

11. A method for adjusting a work schedule, comprising:
storing at least one application concerning a work schedule received from an employee terminal;
calculating a number of employees due to work by accumulating the at least one received application;
determining whether the number of employees due to work is less than a predetermined required number of employees;
selecting at least one employee who is not due to work on a basis of the at least one stored application if the number of employees due to work is less than the required number of employees; and
sending a request to the at least one selected employee to change the work schedule.

12. The method according to claim 11, further comprising displaying at least the required number of employees and a current number of employees due to work on a day indicated in an application on an application screen of the employee terminal.

13. The method according to claim 12, wherein each application concerning the work schedule is an application for a vacation.

14. The method according to claim 13, wherein, if the number of employees due to work on a day indicated in an application becomes less than the required number of employees by an acceptance of the application, displaying a message for requesting a stop to a submission of the application.

15. The method according to claim 13, further comprising indicating an alternative day for taking a vacation in the request.

16. The method according to claim 11, further comprising re-determining whether the number of employees due to work becomes less than the required number of employees in response to a change of the required number of employees.

17. The method according to claim 11, further comprising setting a priority level according to each type of application, and selecting the at least one employee to whom the request is sent according to the priority level.

18. The method according to claim 11, further comprising storing a qualification possessed by each employee, and storing qualifications demanded, and if a predetermined qualification is demanded for employees at work, selecting the at least one employee to whom the request is sent from among the employees possessing the predetermined qualification.

19. The method according to claim 11, further comprising storing a work pattern of each employee, storing the required number of employees according to each work pattern, and selecting the at least one employee to whom the request is sent in accordance with the work pattern.

20. The method according to claim 19, wherein, if there are no employees of a required work pattern, selecting the at least one employee to whom the request is sent from among employees of another work pattern.

21. A computer program for adjusting a work schedule, the computer program including program code for:
storing at least one application concerning a work schedule received from an employee terminal;
calculating a number of employees due to work by accumulating the at least one received application;
determining whether the number of employees due to work is less than a required number of employees;
selecting at least one employee who is not due to work on a basis of the at least one stored application if the number of employees due to work is less than the required number of employees; and
sending a request to the at least one selected employee to change the work schedule.
